(19) United States
(12) Patent Application Publication
(10) Pub. No.: US 2023/0260033 A1
(43) Pub. Date: Aug. 17, 2023

(54) C.P.L.T. and free energy

(71) Applicant: David Andrew D'Zmura, San Diego, CA (US)

(72) Inventor: David Andrew D'Zmura, San Diego, CA (US)

(21) Appl. No.: 17/803,107

(22) Filed: Feb. 11, 2022

(51) Int. Cl. G06Q 40/06; G06Q 40/04

(52) U.S. Cl. CPC G06Q 40/06; G06Q 40/04

(57) ABSTRACT

A Business Method Invention to transact an Independent Inventor's Intangible Assets into Industry of Inventor's native Nation. A Process means to convey license usage to top-most Governmental and Industry leadership agencies and corporations, providing the formation, booking or floating of Treasury Assets, a cash-equivalent ledger item on the Asset-Side of the Balance Sheet. Also, a net-equal tangible value Swap of the pro-se Independent Inventor's IRS-governed Fair Market Value amortization deduction, said Swap to USA Federal or other major municipality, providing Government a tool for Demand-Side economic stimulus, over a fifteen-year period, by distributing Its swap value as per capita US taxpayer or citizen or business tax relief, or synthetic pay raise, or to targeted needs situations. A business method configuring a central bank or Treasury balance asset based upon the financial value of a nation's expired Intangible Assets. A process producing an inner product of mass and energy, this process a prime cause of universal expansion.

### RELATED ASSIGNMENTS

My Assignments 029497/0372 recorded Dec. 14, 2012, 03241/0495 recorded Oct. 26, 2013, 032111/0356 recorded Jan. 16, 2014, 032713/0681 recorded Apr. 7, 2014.

Personal Property, Invention and patent application, of David Andrew D'Zmura, US/US, a pro-se Independent Inventor, wholly and entirely without any attorney, agent, collaborator, a sole Inventor, sole Applicant, sole Author, sole Owner of This Invention and of the Example Intangible Assets and IRS FMV Deduction represented herein.

### STATEMENT

I did not make this Invention in hire, or in express Government contract. I did not make it for or with collaborators, agent, or attorney. All rights reserved by me, without countervention, appropriation, partition.

### I DECLARE

I am the sole inventor, sole lawful applicant and representative hereof. I have received no contract or payment at all to date.

### BACKGROUND

Beginning with my first patent application, in November 1996, I have pro-sc independent invented and authored in entirety, as well as filed, corresponded, responded, claimed and prosecuted over 100 inventions, typically bonafide, at the United States Patent and Trademark Office (USPTO). Starting with 10/31/1989, I have registered copyright on my Works of Authorship, sole Author in Entirety of the Totality of the Works, at the United States Library of Congress Copyright Office (LoC). Throughout my twenty-five years as a filing independent inventor, I have typically registered my Copyrights on my patents and patents Pending, and, in receiving Registrations concurrently, have doubly-attested, and reciprocally, been doubly-attested, with USPTO and LoC, as the sole and actual inventor, author and owner of my Works (Intangible Assets), moreover, have earned and gained protection of my Rights and Entitlements in both patent and copyright arenas, wherein, in second case, my Rights/Protections are worldwide, long-term (my death plus seventy years) and cover my mathematical formulae, coded algorithms, compiled computer programs and spreadsheet software, in addition to text, drawings, music, art, composition, performance, recordings. I have labored alone. Still without any licensee signed or royalty received, I made O/CPLT.

In discussion and work-up with the Internal Revenue Service, I (pro-se independent inventor, author, owner) was granted, in 2005, a valuable personal, individual, Fair Market Value-based, fifteen-year straight-line tax amortization deduction facility, which instates and is usable against any earnings from my Intangible Assets (I have never received any royalty to date (Aug. 30, 2021), nor have I relinquished my Rights (everyone is expressly prohibited from use, commercialization, distribution, etc., of my inventions, authorships, music, etc., by Law). Thus, in two manners, Offices, Authorities and Auspices of the U.S.A. and World have examined and determined that my Works have value and usefulness: on the one hand, as Intangible in nature, having novelty, industrial application and usefulness, by the USPTO and LoC; and on the other hand, as Tangible in nature, my labor, creativity, dedication, productivity and innovative gifts and efforts, meriting that I hold a tangible value (actual nominal) Fair Market Value tax facility. These two accrediting and examination Authorities are counter-parties thereunto, bona fide, legitimate value of my Works.

So, the attestation parties of the U.S. Government, respective Intangible Assets, A) Intangible merit of the works—the USPTO and the LoC; and B) Tangible merit of the works—the IRS, both have certified my trove of invented and authored Works as well meeting standards—being of and for economic, business, commercial, investment, development and industrial value.

### TECHNICAL FIELD

My invention structures financial processes and methods, comprising accounting, asset and liability bookkeeping, royalty payment and investment asset underwriting, taxation and licensing matters, incumbent to the items termed intangible assets, such typically including intellectual and copyright properties, patents, inventions, trade secrets, works of authorship, musicianship, artisanship, also, formulae, mathematical equations, algorithms, computational codes, computer software and spreadsheets. Separate hereto are other intangibles of goodwill, franchise value and name.

### DETAILED DESCRIPTION OF THE INVENTION

My invention, structuring Intangible Assets (IAs) for book maintenance, accounting, credit examination, investment, payment of royalty, provision of use license and tax deductions, starts by transforming IAs from the Liability side of the Balance Sheet, to the Asset side. This comprises the invention's first inventive step. In traditional accounting, IAs are placed on the Liability (right) side of the Balance Sheet, because, often, payment of royalty is made to the inventor or owner of the IA. In the case of a corporation with its own Research and Development, the creation of an IA may be internal to that firm, and also, possibly without any fixed royalty paid vis-a-vis the IA, yet, the IA, in bookkeeping, still stands on the Liability half of the Balance due to costs incurred. Yet, in this second case, the company, having made the IA, thus owns its IA, and uses it in its business for its value.

Compared to European financial statement practices, the American practice has aspects which create lowered safeguards, slowed enactment of safeguards, and muddled functionalism between components, all of which can serve to reduce the actual, apparent or impression of a company's credit rating, financial security or solvency, and ability to borrow or attract shareholders. One of such area is Intangible Assets (IAs). Because an IA, on American books, is placed Liability-side, it often requires reference or writing as Off-Balance Sheet item. Off-Balance Sheet items, and the footnotes, and sometimes convoluted arrows into other components of book, defacto, obscures accounting, which in turn is devalued by examiners issuing credit grade, as well as de-motivates potential buyers of the company's stock or bonds. Dependent on the origin and ownership hold of an IA within the company, such as being an asset it directly created and owns, its placement into Liabilities is clearly opposite its nature, and has led the Balance Sheet component of IAs to be toward a slush field on book, juggled to meet requirement that company Assets equal Liabilities. Typical Assets on a Balance Sheet are cash, cash-equivalents, real estate owned, capital equipment owned, etc. Also, the net of company treasury is reflected, comprising its portfolio of cash, stock, bonds and government securities it owns. Because an IA can be sold, can be leased/rented for a periodic return and carries a value in its Rights and Entitlements to use, to permit and to prohibit, my Invention structures IA as Asset on Balance Sheet, and moreover, as having inherent value, enabling a security to be underwritten with the IA as its basis. In first step, the IA is levered, or provided, up to an underwriter, in this case, the U.S. Federal Treasury, which issues Treasury bills, Notes and Bonds, as well as backs a wide assortment of securities with varied bases, such as real estate. In this case, a Treasury Asset is made by the U.S. Treasury, whether with purpose to be traded openly or at all, sold to the public, or held internally as a core stockhold of the U.S. Treasury, much as the U.S.A. holds gold, which aids it to float new Treasury issues at auction. Moreover, as each IA has a specifically attached set of rights and entitlements to use, license, manufacture, for instance, a specific invention, that set of Rights and Entitlements is held by the U.S.A., at Federal level, and can be directed, implemented, rented or sold, as part of a publicly-issued security, as an enhancement to existent security, or a simple a transaction of the Rights and Entitlements, without any financial fixed-income instrument body. In my personal case—an example of my invention CPLT embodied—of IAs which are virginal, not licensed or transacted, or invented elsewhere, the Nation, U.S.A., can obtain top-down use rights, adding the IA as asset to the Federally-held wealth. In the case of a corporation with different IAs it holds on the Liability-side of the Balance Sheet, with and through levering to the U.S. Treasury, that corporation can retain its IA, but on the Asset-side cleanly, in the form of a U.S. Treasury-backed Asset. The following cases of Treasury Asset apply:
1) virginal IA is up-levered to U.S. Federal Treasury inclusive of its Rights and Entitlements;
2) IA bearing a royalty contract of promised payments is up-levered to the U.S. Federal Treasury inclusive of its Rights and Entitlements;
3) IA of a corporation, booked on the Liability-side of the Balance Sheet is transformed to a financial security of the Asset-side by up-levering the IA to U.S. Federal Treasury or other securities underwriter, retaining its Rights and Entitlements.

In so far as transferring an IA's Rights and Entitlements to the U.S. Treasury or other underwriter, royalty payment to the inventor or owner of the IA being transferred can be variously structured, as, eg. interest-only (STRIP), one-time cash-out, E-type zero.

While it may be theoretically possible to co-package almost anything together with the IA's Rights and Entitlements, the obvious attached package of basketed values, is the Royalty/License Fee component, in exchange for transferring the Rights and Entitlements of the IA. A second, rare, basket of values directly attached exists in the case of a pro-se (by oneself, for oneself, without attorney, agent or affiliate) independent inventor (not in hire, nor salaried employee, or in specific Government contract, in the act/practice of inventing), such as myself, but only with and by permission of the Internal Revenue Service (as of 2005). This set of values, I call Savings, and it formally is the Fair Market Price of the Invention created by the pro-se Independent Inventor, bundled together as aggregate of the patent life basis, discounted to present value, wherein, that discounted aggregate serves to establish the tax deduction which the pro-se may take against royalty actually received, on a 15-year straight-line amortization basis; divide eg. by 15.

As of 2005, only a pro-se Independent Inventor could be granted by the Internal Revenue Service a tax amortization deduction based of the Fair Market Value method. Generally, a corporation (or dedicated invention business, fully funded) has fully itemized components contributing, by line item in actual nominal amounts, to the corporation's inventing activity. Such include, scientists, researchers, receiving job salaries, laboratory, real estate and equipment fully scheduled, attorneys and staff writers, draftspersons and typesetters completing patent filing descriptions through to prosecuting a patent application to issuance with accepted claims. These itemizations (not fully inclusive) are the corporation's cost of inventing, and along with depreciation of IA schedules, comprise a company's IA accounting, deductions.

For a pro-se Independent Inventor, there are no itemizations of the inventing itself. While the USPTO does charge fees for filing an application, as well as other fees at steps through to patent issuance and maintenance, these fees are those associated under cost of patenting, and at that, are paid to the USPTO to review an application. Essential, then, is to understand, the FMV deduction is used, due to absence of itemized inventing costs, and pivotal, that the FMV deduction is granted to a inventor, a pro-se Independent Inventor such as myself, who is a person, an individual, with the FMV deduction made on the inventor's personal 1040 Schedule C, ‘other’. Conversely, the FMV deduction is not attached to any, or to any specific, IA. The FMV deduction is used against income received from inventing.

To note: I was granted by the Internal Revenue Service, at meeting in first-half 2005, permission to use the FMV tax amortization deduction, against royalty (or other IA-related) income, should or when I receive it. This was when I had just one patent, and the annual deduction for the fifteen-year amortization was estimated at $14 Million. I am a pro-se Independent Inventor. One cannot assume that any pro-se can use the FMV method, for it must be formally (written) permitted by the IRS. Likely, it is more reserved for pro-se's who are ardent, long-time inventors, and whose Works are of profound market impact, consequence and value. Be that as it may:
following on my invention of the Treasury Asset process (December 2009 to April 2010), I considered that, in the event I receive royalty as interest payments from the U/S/Treasury (whether as a full par, face-valued, fixed-income instrument with periodic coupon, or not), interest (rate) payments from U.S. Treasury are tax-free to those who receive them (standard feature of U.S. Treasury instruments). Thus, I said to myself, I would not need to use (much) my IRS FMV tax amort deduction, as I would not owe taxes on my royalty if paid from U.S. Treasury. Fantastic, I said, that may enable me to use my “Savings” (FMV) value elsewhere—like, to help Our Government have additional money for Our People and Our Budget. So, I invented a second process, “net-equal value swap with Civic”. Background: two parties may swap with each other like assets/earnings/value (such as real estate), and their taxes in tow (their net) as long as, at each end, approximately equal value is netted by each party. A swap, a legal financial maneuver, requires that net-equal value guidelines be enforced, that swappable is like, and parties, appropriate.

In addition to my Intangible Assets, list provided in figure, I have a tax abatement=my FMV tax amortization deduction, granted by the IRS. A tax abatement has a useful, nominal actual value, against general income, about 1:3 (tax rate 30% to 35%) person or business. To result as net-equal, divide both ends by two and its capture is about 1:6 (one to six). If there was taxable income of $100, and we (USA & I) desired to swap to get net-equal value:
USA has $100, tax ⅓: $33 tax due;
Swap: USA gives me ⅙: $16, I give USA $33 tax abatement;
Result, instead of USA paying $33 tax, USA pays me $16 and my tax abatement ($33 used) pays USA tax.

These conditions pertain to any swap I can do with my specific (inventor's) FMV, which pays each year for fifteen years:
1) I must receive royalty each year in order for it to become enabled that year—if USA Federal Government up-levers my IAs to Treasury Asset, said TA pays me royalty as income from U.S. Treasury;
2) Royalty need not be from U.S. Treasury, however, U.S. Treasury income is tax-free, thereby facilitating all of my FMV for Swap;
3) my FMV deduction facility calculates as large, each of fifteen consecutive years from onset, hence, appropriate party to swap could be a very large economic entity or municipality;
4) my Swap value is tax abatement, hence, following structured process:

O/CPLT [Our (USA and I)/Counter-Party License Transaction]: if USA licenses/levers up my IAs into Treasury Assets paying me interest as royalty, but also using my FMV to U.S. Treasury enables Our President to give everyone a tax abatement, and not just once, but for fifteen consecutive years, perhaps at over $1,000 a person each year, possibly some to targeted U.S. Business. Due to National Franchise scaling, applicable swap rate could reduce to about 1:19, with my retention of my personal Right to run my own IAs' businesses. Without retention of Rights, about 1:15. Alternately, a large Municipality or Corporation might suffice. In conclusion of the SUMMARY and BRIEF DESCRIPTION of the INVENTION, my said invention, IA/CPLT, “Intangible Asset/Counter-Party License Transaction” provides two independent inventions, both of which provide economic value to industry and to the Nation. First, the invention provides process transferring Intangible Assets (IAs) from a Liability-side, often Off-Balance Sheet item, aiding accounting transparency and general credit worthiness, ceteris paribus, to the Asset-side, on balance sheet item, when as packaged into a Treasury Asset, having top-tier asset strength as near cash-equivalent asset. Second, the invention provides a process converting a pro-se independent inventor's personal IRS FMV tax amortization deduction into, or through, a net-equal swap with large civic and municipal entity or entities, for instance the U.S. Federal Government, for ends producing a general per capita, or targeted business, taxpayer abatement, causing by increased retention of income and greater discretionary funds on hand for each recipient taxpayer—an atomistic-driven Demand-side stimulus to the Economy. This stimulus, of sustained fifteen year fiscal cycles impacts the consumption-focused industries of Our Nation, helping to spur increased purchases of consumer products and services, while informing the supply-side companies throughout the 15-year-cycle of consumer wants and needs, while also adding more revenue to the operations, so as to afford these supply-side companies with the wherewithal at the margin to implement informed transitions and management plans to best move forward with trends and other demand-side characteristics. The fifteen year cycle Demand-side stimulus provides excellent complement to the value my IAs provide elsewhere.

The principal value sectors of my invention, also entitled, “Our (USA & I)/Counter-Party License Transaction”, deserve summary, so as to appraise, identify and review the cost/benefit impact areas on related industries, economic and financial function, and the Economy's performance. Summary in outline form:
1) CPLT licenses a catalogue or collection of Intangible Assets (IAs), so that industries related to, and benefiting from the IAs, are formally permitted to use and production Rights, enabling industry. For License to be of business contract measure, the Inventor/Owner of the IAs, and the Municipal Entity (eg. USA), must sign, and, on signature, as well as periodic, Inventor is paid royalty by the Licensee, with three-years (of payments) being worldwide basis of business (contract) operation, solidifying Licensee's Rights to continued usage and production of IAs in event of Inventor's death. Should Inventor die, with IAs unlicensed, signing and contracting Rights is no longer feasible, and IAs, value zero absent paying contract, cannot pass to heir or Licensee on death. The Assignments made are contingent upon payment.
2) Inventor may always have intrinsic, inalienable Right to use and produce one's own IAs, even if inventor has licensed them to a industrial user or municipal entity. In CPLT, this safeguards the National Government, as, in event of poor performance by an industrial sub-license, the Government, via Inventor, retains option and ability to add other sub-licensees. Similarly, in the event the USA wished to sub-license a foreign Nation or company, the USA, paying Inventor retainer, can hold or effect option to use and produce the IAs domestically.
3) By up-levering IAs to the U.S. Treasury, per O/CPLT, the USA gains core value in central reserve, which can assist fiat issuance, can be stacked onto U.S. Treasury instrument to enhance financial nominal and Rights value, or be refined as an IA-based Treasury Asset.
4) Providing specific operating industries, or specific companies within industry sectors, licensed use and production Rights of IAs (the IAs industrial applicability and usefulness already is examined and ascertained in the USPTO patent search, examination and issuance process) aids the competitive, opportunistic and financial goals of these industries and/or companies. Whereas typically a company might individually license an IA from inventor directly, which usually contractually operates to exclude and prohibit all other economic participants from use and production Rights, and, hence, Licensee pays Royalty to that Inventor, by O/CPLT, USA Federal Government can multiply license, some, many, or all, companies within an IAs industry, thus, greatly expanding the usability and production domain of the IA in the economy, and thus, multiply, this effecting production, savings and profitability economics and improvements within Our Nation's Economy. As licensees of the U.S. Government pass-through of the IA use and production Rights, the IA-recipient industries and/or companies (sub-licensees) properly under intellectual property contract law, could or should pay royalty to their Licensor (the USA., In turn, the USA may elect to forgo royalty fee collection, judging the Nation's Interest is assisted, as the sub-licensee's Rights to the IA, improve its outlook, stability, job base, profitability, growth, return on equity, and taxable revenues, which operate as returns for Nation. Thus, the consolidation of IA at U.S. Federal level opens up the dispersion of IA Rights, and supervision thereof, to comprehensive means.
5) The invention herein of a Treasury Asset (TA) is remarkable in the functions it serves, and, unique in the world of finance. In order to simplify matters of royalty to inventor of the IA, in licensing up to the U.S.A., to U.S. Federal Government direction, for distribution, restriction, permission and prohibition, and supervision, and collection of royalty, as It sub-licenses the IA into and among the industries, and specific companies comprising industrial sectors, the Treasury Asset carries use and production Rights. The magnitude, nominal, of the Treasury Asset can readily be set as determined by the annual operating revenue, devoid costs, of the industry, or of specific company—at least with respect to operational sectors in which the IA has import and brings value added capabilities to performance. Thus, Economic/Revenue Scope (an approximate magnitude). This number is a book-item (Face Value). Hence, in distributing and dispersing use and production Rights of the IA to the U.S. Government, the U.S. Treasury and Its Assetholder on behalf of Our Commonwealth, the Federal Reserve Banks bookkeeps matters. As royalty must be paid to the inventor to constitute a valid license, and permitted licensee, or assignee, it is efficiently accommodated via the TA. Based on U.S. policy, the licensed industry, industry leaders/companies, will receive sub-license (under USA) gratis, or at charge fixed, or by open bid or auction (where exclusive or sub-licensing Rights may be part of TA). Sub-licensees(s) pay periodic to U.S. Treasury. U.S. Treasury pays periodic to inventor. The specifics of each Treasury Asset, is kept on book at U.S.T/FRB. Any trade, alteration, periodic appraised of Revenue Scope, is pre-advised and recorded by UST/FRB. Feasibly, an inventor might be guaranteed in contract the U.S. Treasury payment per annum, a percentage multiplied by the aggregate Revenue Scope (aka Face Value), licensing the inventor's IA. In addition, on Royalty received from industrial licensees via the US Government, might be split between inventor of IA and FRB/UST of TA. Point being, inventor of IA (by Law) requires being paid royalty, with assignment to the US Government contingent on payment.
6) By way of the Treasury Asset (TA) issuance of Licensee Rights, each TA carrying a revenue-impact value, as well as a royalty rate charge to sub-licensees (if none or little, then, USA People are subsidizing Licensee). Nonetheless, on the basis of summing together all Revenue Scope (aka Face Value) numbers for a given IA, the sum aggregate gives an economic indicator of the market scope of that IA, and, irrespective of whether a real royalty rate is charged industrial sub-licensee or not, it is a fair indicator. On that basis, once mature (licenses in place), the aggregate of all Revenue Scopes for Licensees of a given IA, is a Fair Market Value of the IAs' market, applicable market(s) of impact. Similarly, the aggregate royalty income which the inventor receives from FRB/UST on his/her IA, divided by a Fair royalty rate governing payment (i.e. minimum contracted floor, plus paid or phantom (subsidized) additional royalty rate), determines the Fair Market Value, of importance in calculating (any) applicable inventor's IRS FMV tax amortization deduction. Thus, (see FIG. 1F), an equivalency exists, and can be used to evaluate, conjecture and approximate both the Treasury Asset market for an IA, but, also, for establishing the Demand-side stimulus available, via net-equal swap, by calculating the FMV tax deduction—for both link to, and work to inform, the Fair Market Value of an IA, wherein, FMV determined from either side should concur, or can, if need be, used in lieu of a determination not forthcoming on one side. Hence, to determine the Fair Market Value (FMV) for an inventor's personal IRS tax deduction, assuming herein said Intangible Assets (IAs) containing copyrights (protections worldwide, death plus seventy years), having capacity to lever-up Treasury Assets of centarian (100 year) term nature: it is the Present Discounted Value of the sum of the 100-years of royalty rate applicable to the Treasury Asset of “Face Value”, Revenue Scope, PDV|¹⁰⁰EiTA_{FV}|, where i=royalty rate per annum, and FV−Face Value=Revenue Scope. That is the Fair Market Value of the Inventor's IRS personal tax deduction.

This business method invention also configures a financial asset through a Counter-Party License Transaction, said asset accorded to the Federal Treasury and/or Reserve Bank; this asset is based upon the wealth of expired Intangible Assets, these assets being the expired patents and Copyrights and Trademarks. This wealth, by prior art, is nowhere on asset or balance sheets, neither public or private, yet the savings from expiration is vast, and can be held to exceed the annual value of on-the-run Intangible Assets, this latter value being for the United States over $30 Trillion. Examples abound of Intangible Assets in unprotected usage, for instance, generic medications. Such medications save the taxpayers billions of dollars per year. Another form of this wealth comes from the improvements of technologies and techniques driving the increase in life expectancy.

Said wealth belongs to the Public, and the financial asset is placed to the public good in public trust, originating at the Federal Treasury or Central Bank. The Public is credited with this wealth, held as reserve at the Federal Treasury or Central Bank. This wealth can be transacted to or with Commercial Banks or other financial entities, or can be used for underwriting anything from Federal Treasuries to digital currency. The Public interest is most likely managed by Governmental operatives at the Federal Reserve and at the Treasury. International conventions may entitle all Nations to have an asset equal to the wealth of their expired Intangible Assets.

The world's Central Banks and Treasuries are credited with this wealth, on behalf of the Public. The wealth is booked as a financial, a reserve, asset, which can, for instance, be drawn upon or liened against, traded or sold, causing or supporting Central Bank or Treasury funding, instruments, or policy programs. The financial asset, including any cash, interest payments or liquidity provided is used for the Public.

Additional and Supplemental Matter: “Free Energy”.

This invention contains Additional and Supplemental Matter, entitled “Free Energy”. This invention renders the process creating matter and dark matter through the cycling in time of the two states, large-scale and quantum. For each of the slates, a formula of energy is said to hold. For the large-scale state, the formula is E=mc². For the quantum state, the formula is e=mc. The quantum state departs because the speed of light is a constant, and in natural units is 1, wherein 1²=1. Another reason is there is no speed faster than the speed of light, such that lim c²=c. These two causes result in the conditions of equality between E=mc², and, e=mc. Using the speed of light as 1, 0 (absence of light), and −1 (dark light), one can assess the result of the cycling of the states, using subtraction of one state's formula from the other, this is the substance of FIGS. 14A and 14B. What is produced is 2m per cycle caused by dark light (−1) for the subtraction, mc²−mc. For the subtraction, cm−mc², again caused by dark light (−1), is −2m (two units of dark matter) produced per cycle. This is a prime force causing expansion of the galaxy and universe.

The cycling of the states is governed by the formulas for K (large-scale) and k (quantum), duration over time, with these formulas given in FIG. 15. Duration is also shown as given in terms of the speed of light.

### BRIEF DESCRIPTION OF THE DRAWINGS

FIG. 1A: C.P.L.T. describing Front-End License and Back-End Net-Equal Tax Swap.

FIG. 1B: O/CPLT: Our (USA and I)/Counter-Party License Transaction; with Front-End License side-by-side, Amidst the United States of America centering, Back-End of my pro-se sole Independent Inventor's IRS Tax Fair Market Value Amortization Deduction, 15-year, as to USA, Net Value-Equal Swap to US Per Capita, with Tangible Macro-Economic Benefits to USA Commonwealth and U.S. Treasury Asset/Liability Balance Sheet Improvement.

FIG. 1C: Front-End License Detail, Invention of Treasury Asset owned by U.S. Treasury, not Debt or Fiat.

FIG. 1D: Back-End Tax Swap Detail: Historicals
TaxFMVDeduct=Amount, Treasury Asset Up-Levered.

FIG. 2: Core Beneficial Array to U.S. Economy from C.P.L.T.

FIG. 3A: Applicable Licensee Industries, based on Example Collection of My Intangible Assets and Intellectual Properties.

FIG. 3B: Demand-Side Stimulus Via Back-End Structure, based on Implementing Swap of My Inventor's Personal Tax FMV Deduction.

FIG. 4A: Specific Intangible Asset Catalogue of My Personally Made and Owned patents and patent applications.

FIG. 4B: Specific Intangible Asset Catalogue of My Personally Made and Owned Copyrights and Copyright Registrations.

FIG. 5A: Consumption Function, Broad, Atomistic Per Capita Demand-Side Stimulus utilizing my Tax FMV Savings.

FIG. 5B: United States Government: Enacts, Maintains, Requires, with Three Examples to Its Further Use of Capacity from CPLT.

FIG. 5C: “Free Lunch” Achieved for U.S.A. by Inventor, David Andrew D'Zmura.

FIG. 6: of my Will and General License, with inheritance, to the United States of America.

FIG. 7: my written and transmitted (later mailed) text messages to the U.S. Treasury, Which formally Belled it in response, describing quote of terms for transacting O/CPLT.

FIGS. 8A, 8B, 8C: my Inventor's TENDER, with TERMS, I wrote, signed and submitted Jun. 1, 2011.

FIG. 9A: Outlines Formal and Mechanical Structure of O/CPLT, specific mailed Tender, dated Mar. 15, 2011, of my own IAs and IRS-approved tax FMV deduction, with Terms of Tender, with Mandates on Use of my Proceeds.

FIGS. 10A, 10B: to Bi-Lateral Signing of Hard-Copy Contract between U.S.A. and Inventor.

FIGS. 11A, 11B: Inventor's “Parchment” Tender Stand-By, dated and signed of Oct. 14, 2011.

FIG. 12: O/CPLT: U.S. Federal Asset & Liability Positive Gains. This Drawing was included by the USPTO in Its Recordation of my Assignment of all Totality of my Intellectual Properties to the U.S.A. in my Formal Assignment, #029497/0372 of Dec. 14, 2012, (contingent upon Inventor being signed and paid), comprising raising U.S. Federal Assets and Equity by $39 Trillion, plus Multipliers into the U.S. Economy.

FIG. 13: Process and System diagram of the Integration of the Broad Distribution of inventor's IAs to U.S. Industry, under the O/CPLT tendered, with the Back-End Tax Relief to U.S. Industry from the Swap of Inventor's Tax FMV to the U.S. Federal Gov't.

FIGS. 14A and 14B, Additional and Supplemental Matter, are the process of generating Free Energy, which is a created offshoot from the cycling of time, and causes the expansion of the universe, through the creation of matter and dark matter.

FIG. 15, Additional and Supplemental Matter, represents the two states, large scale and quantum, by E=mc² and e=mc, respectively. The process interfacing said two states are governed by the formulas for K and k. Duration, a measure of time, has clock speed of K rendered per the speed of light.

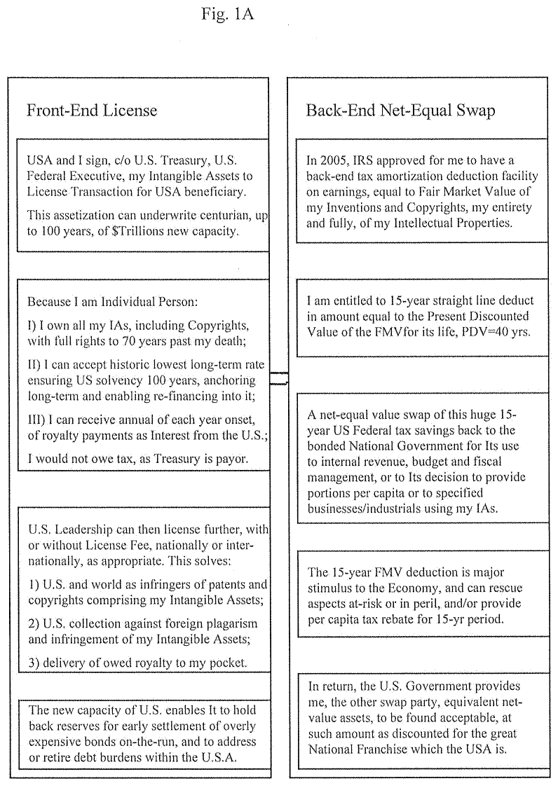

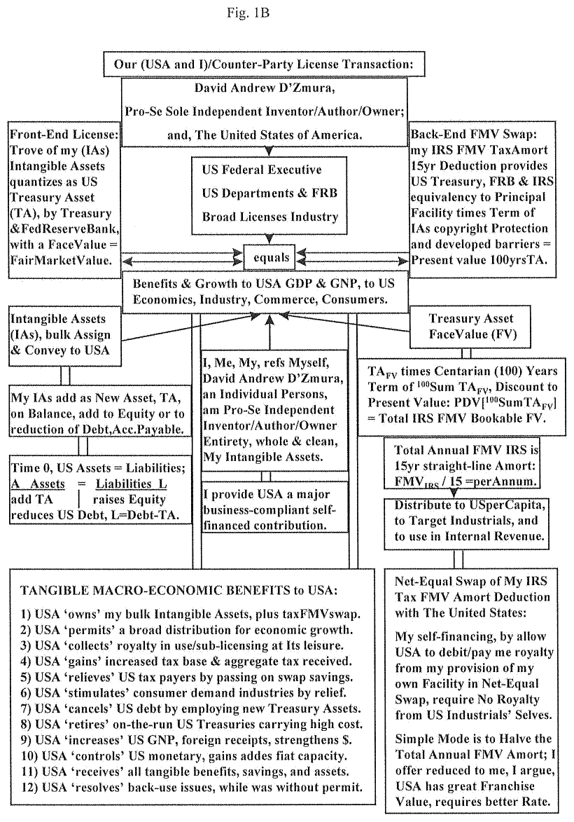

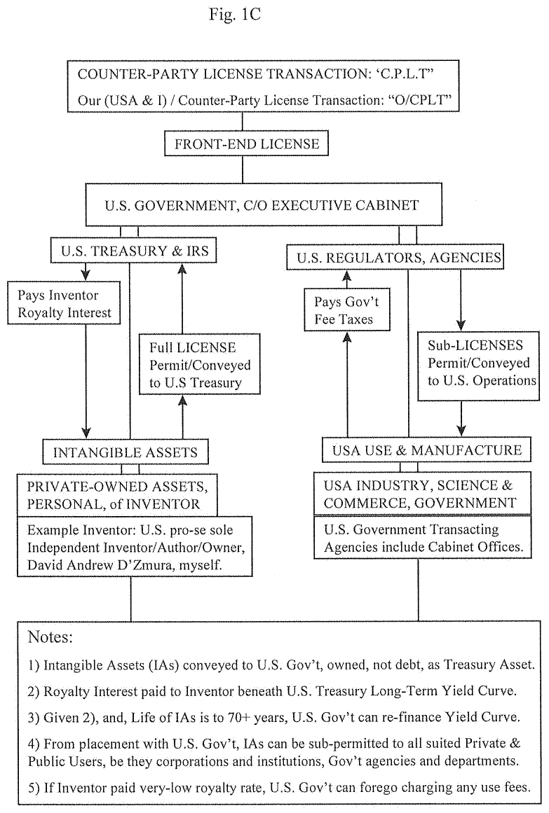

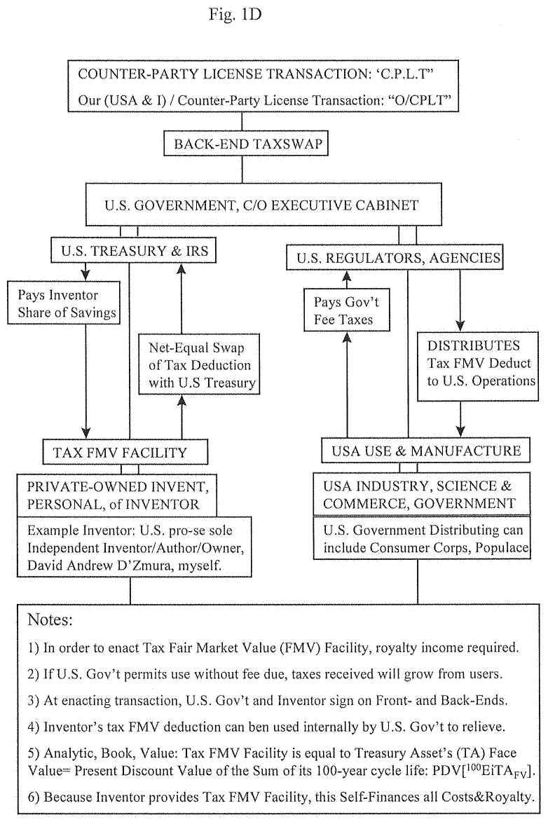

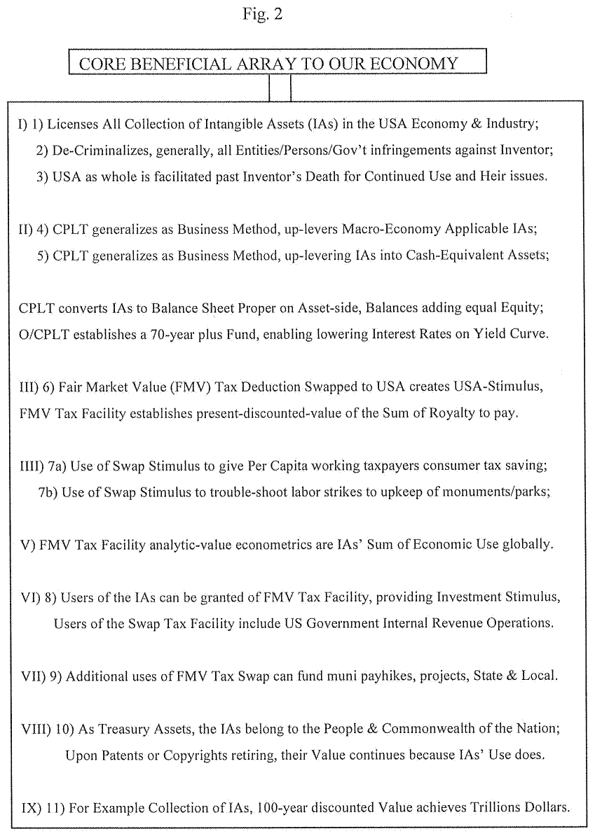

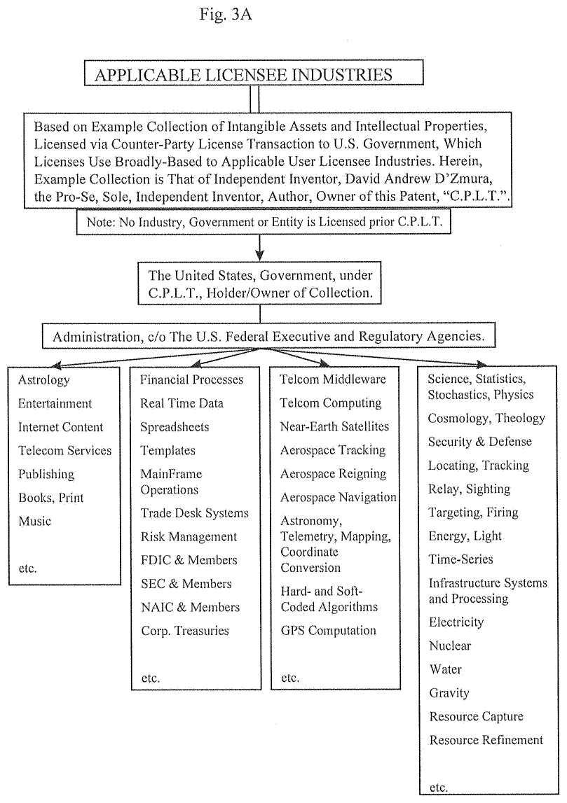

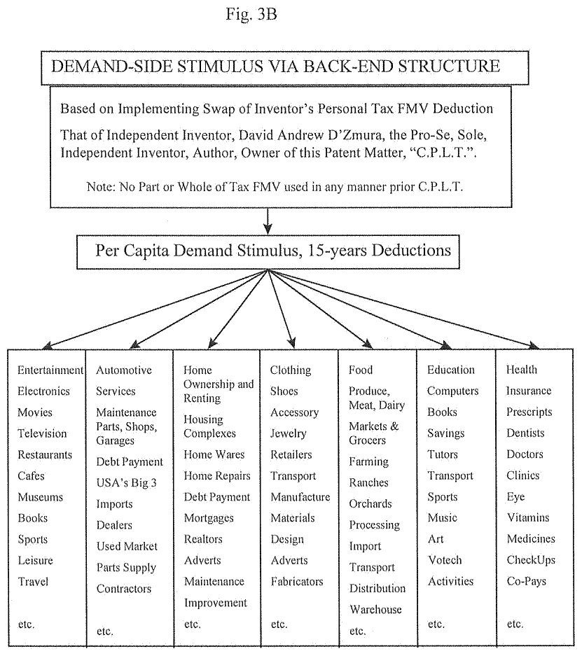

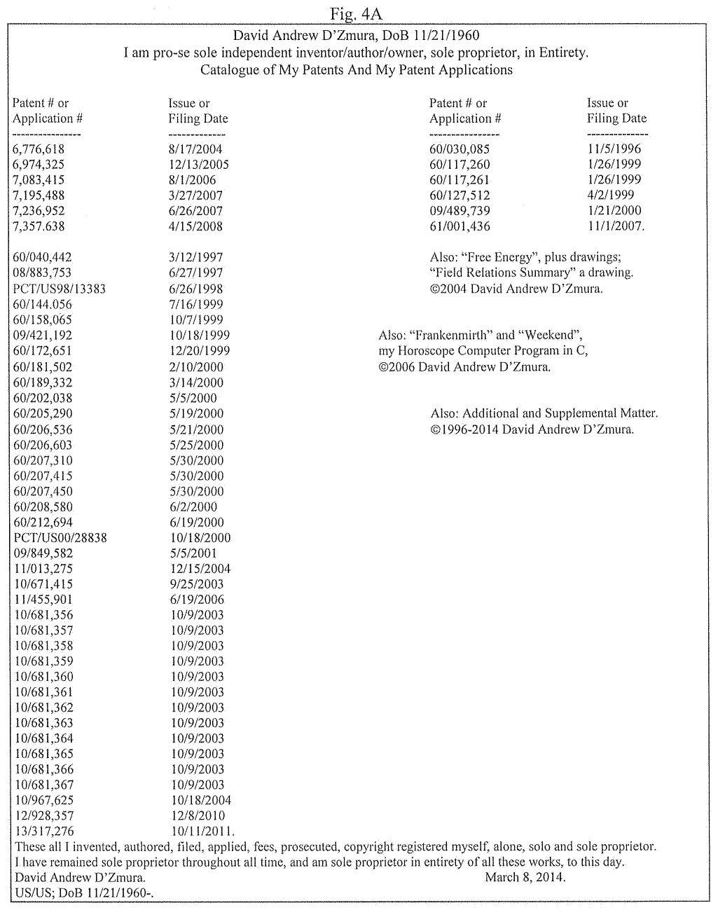

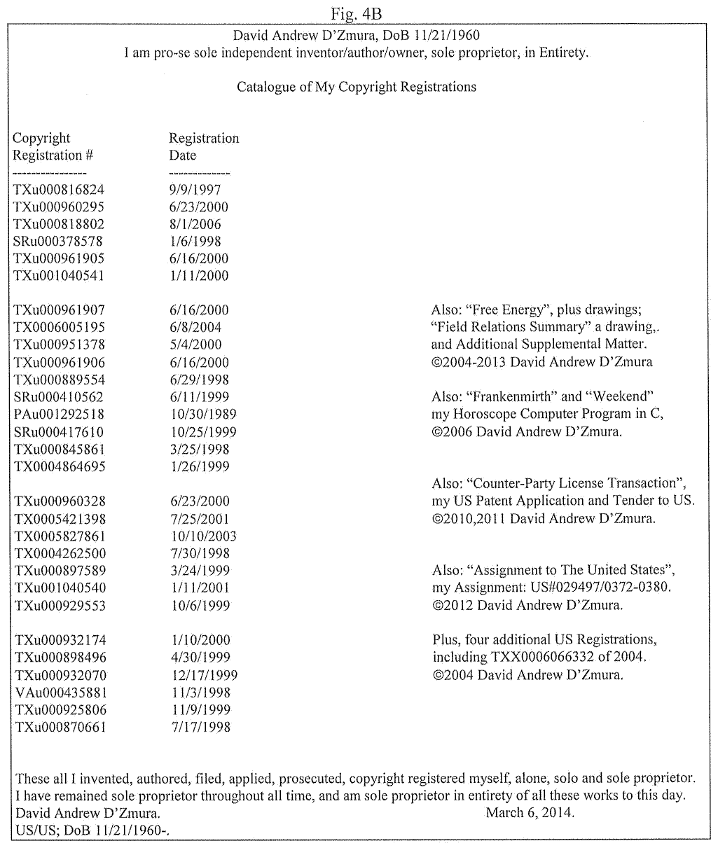

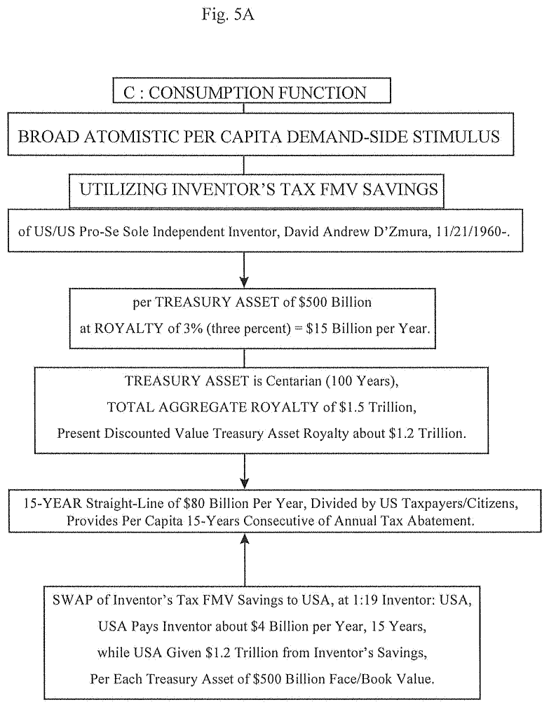

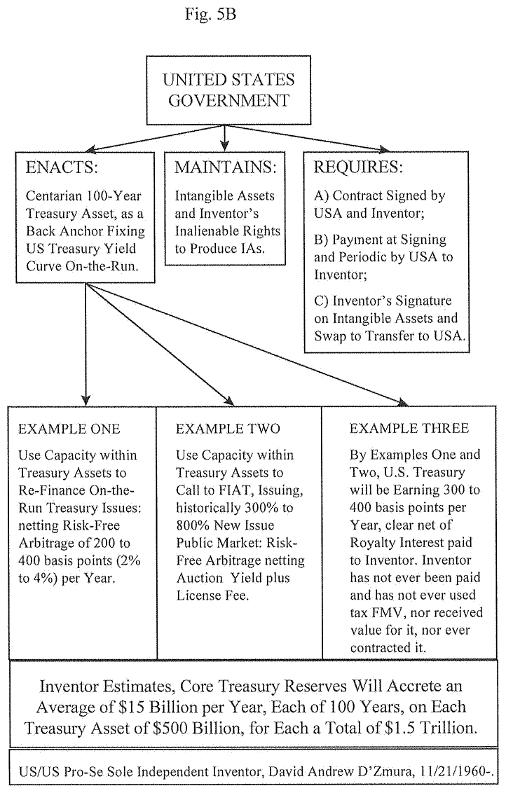

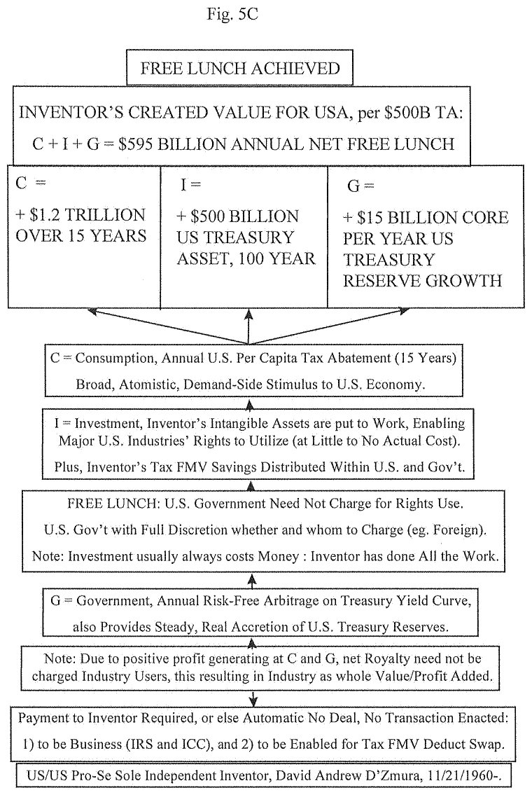

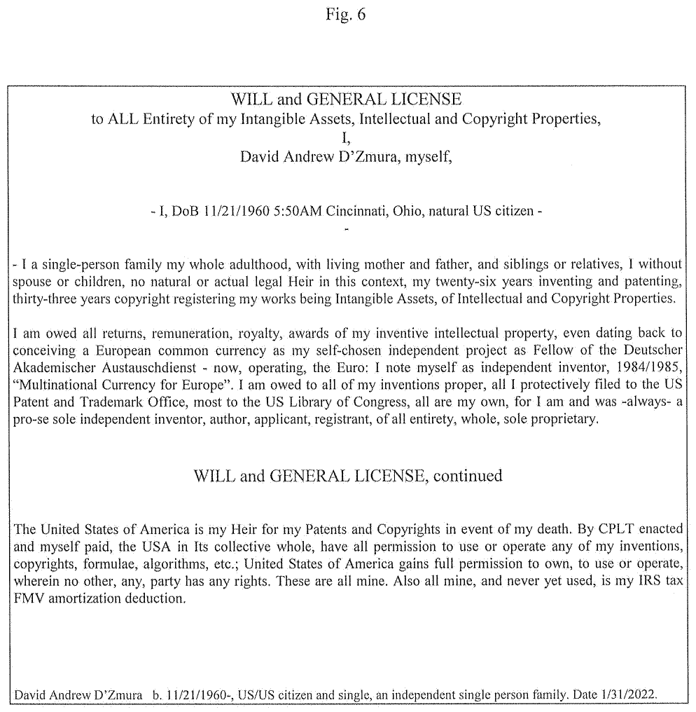

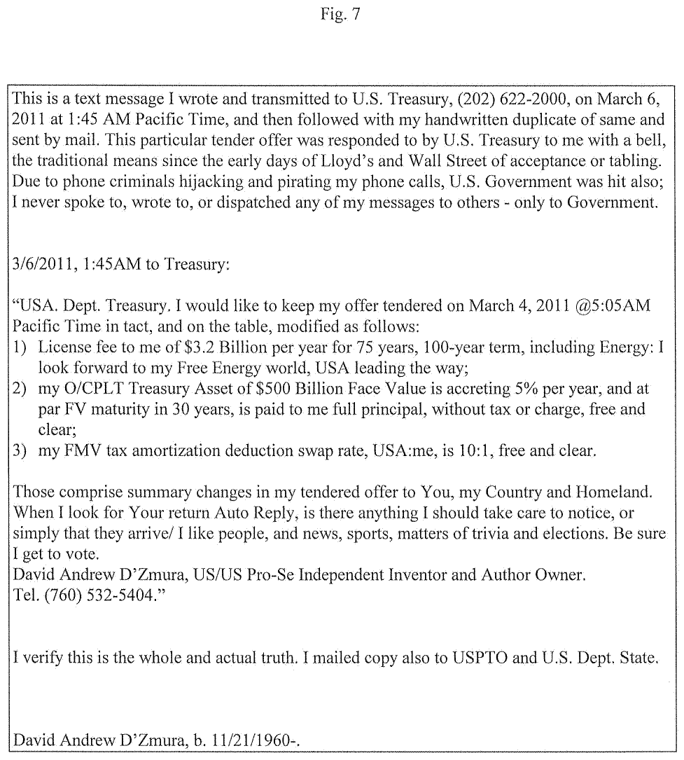

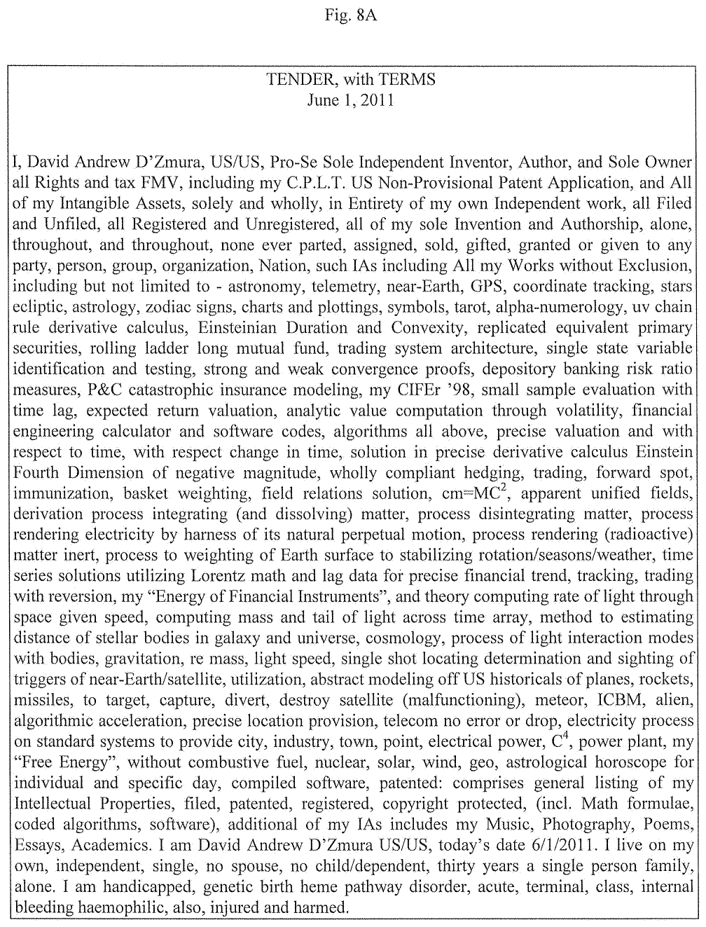

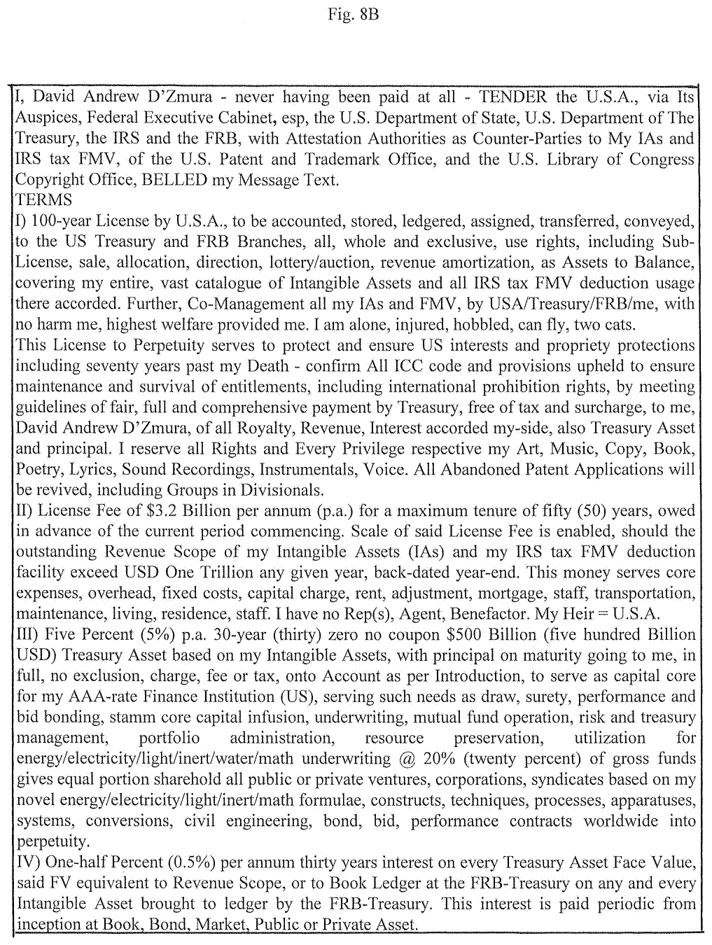

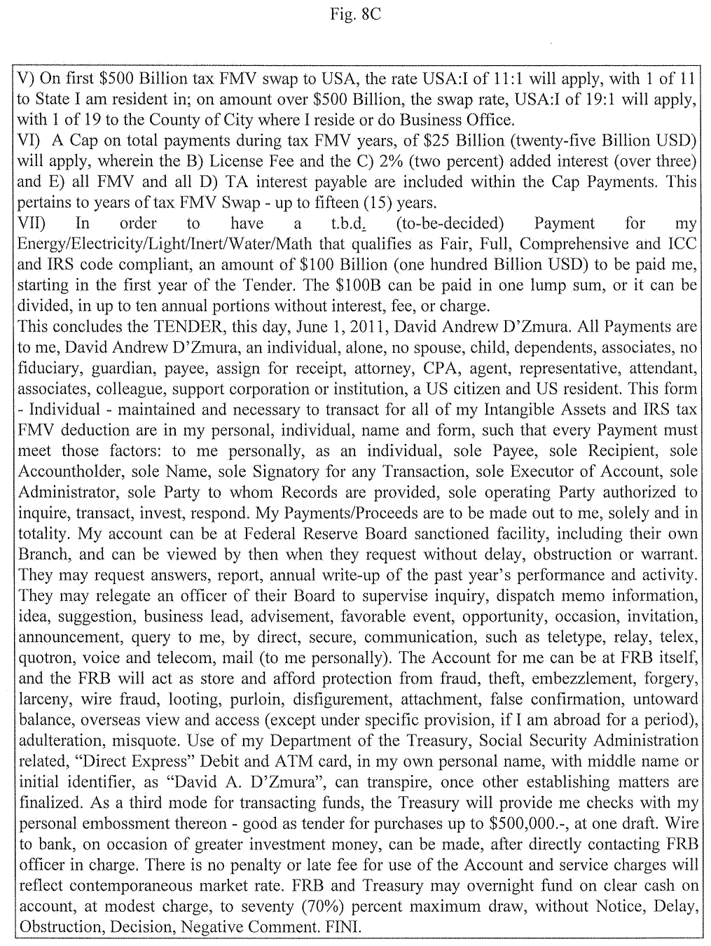

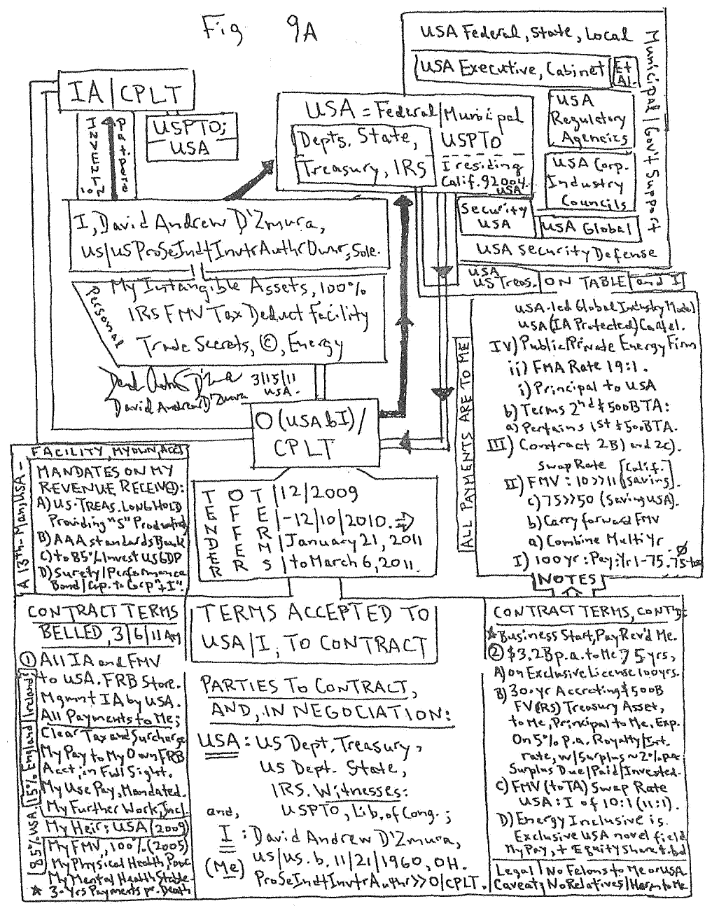

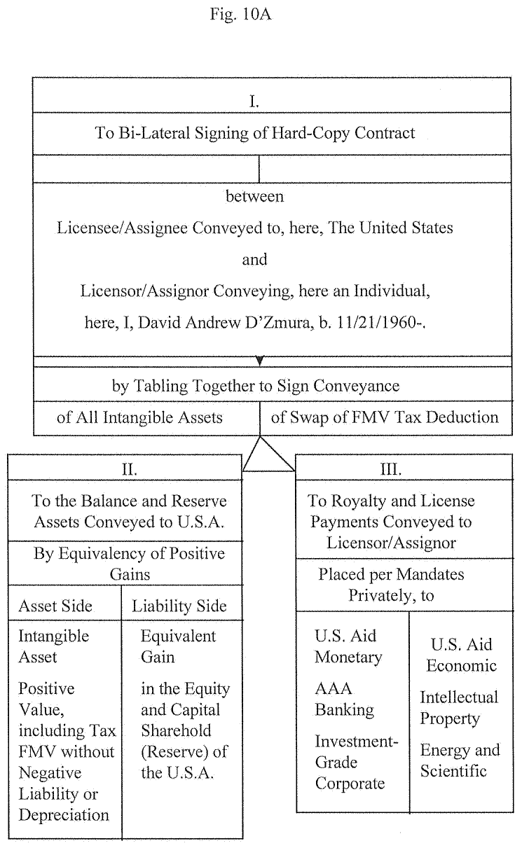

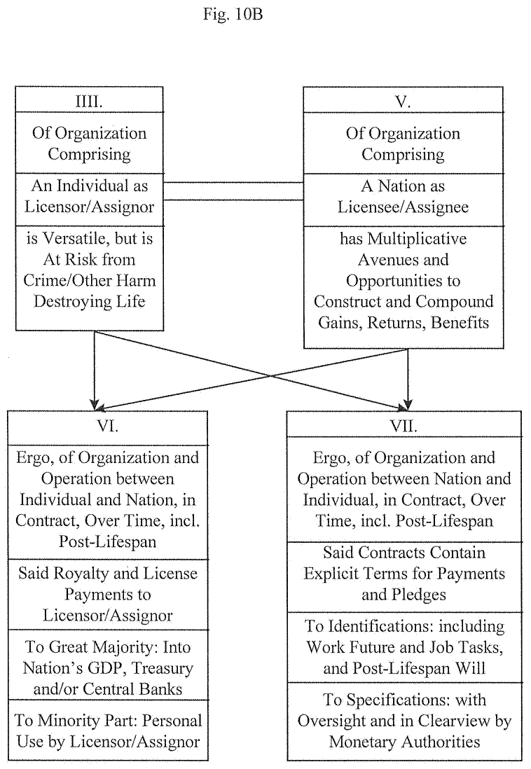

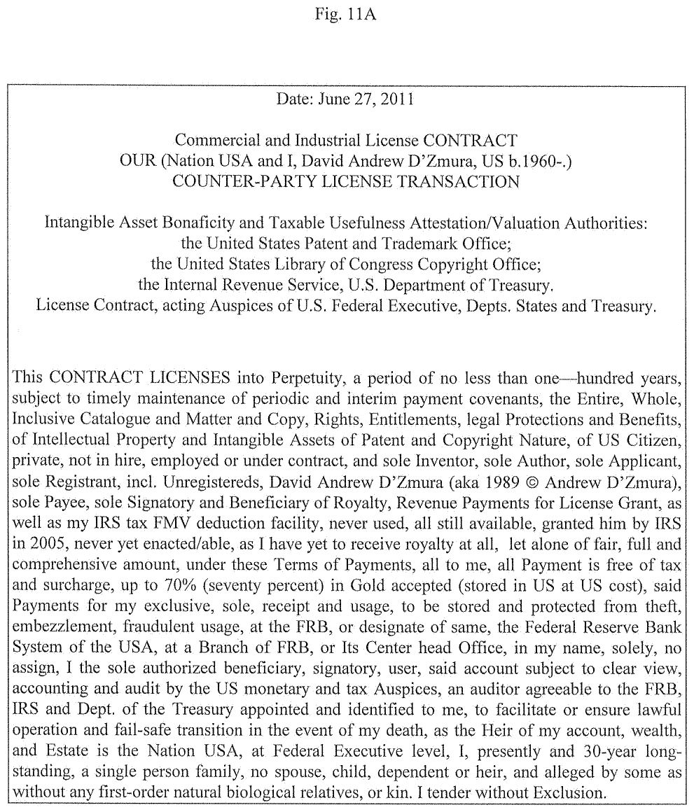

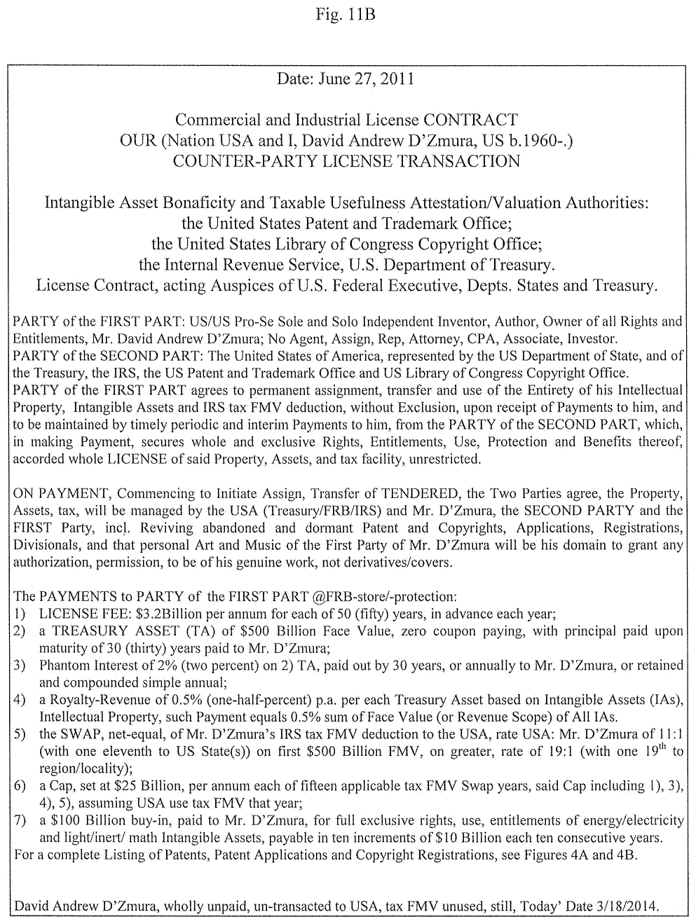

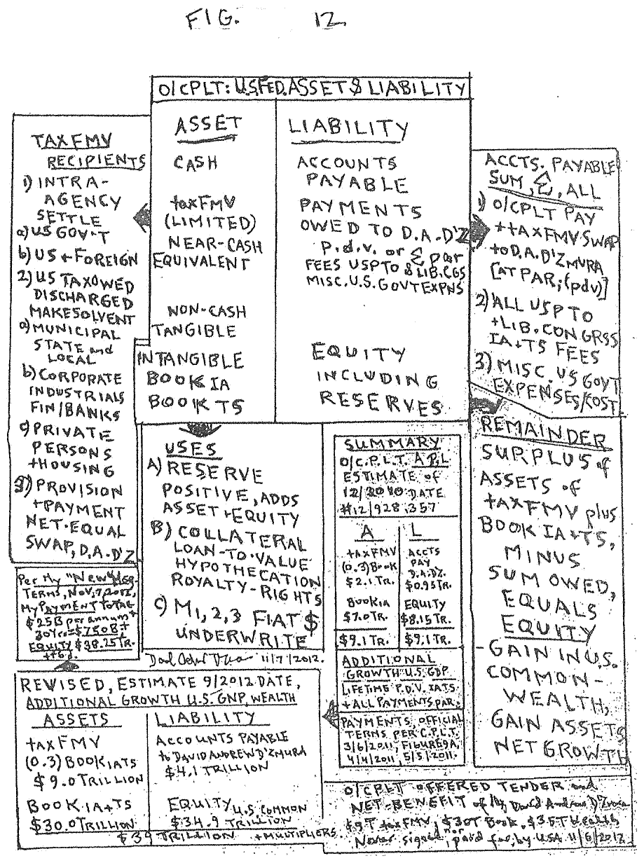

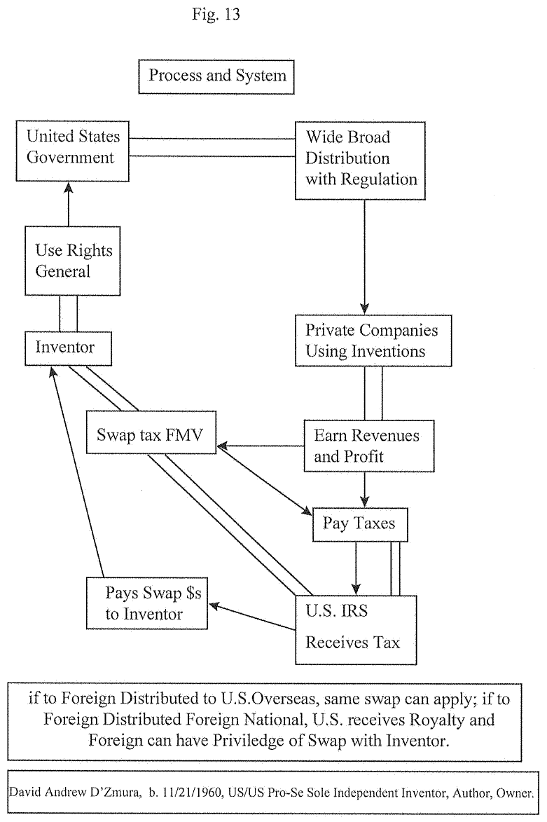

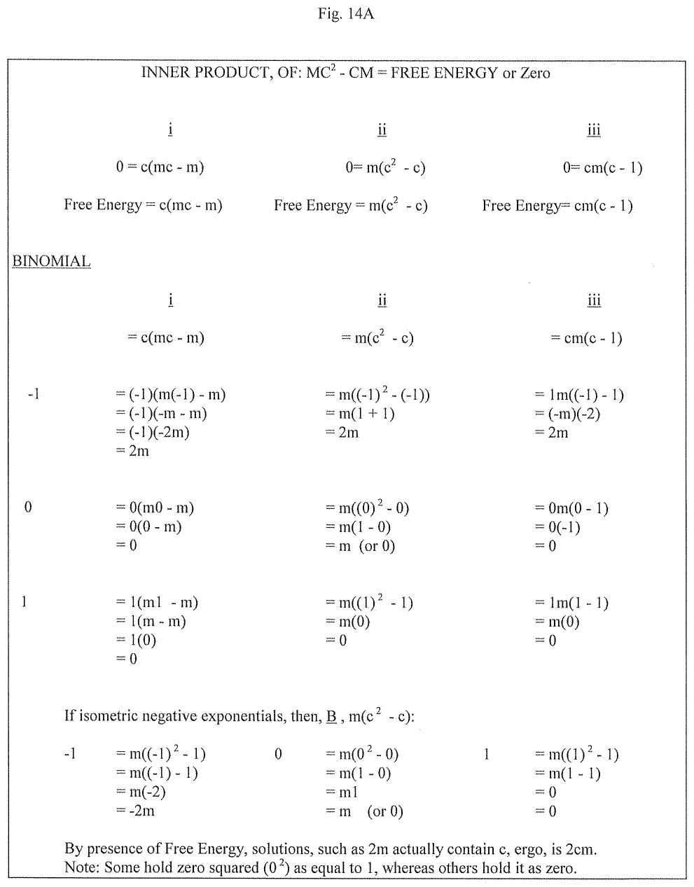

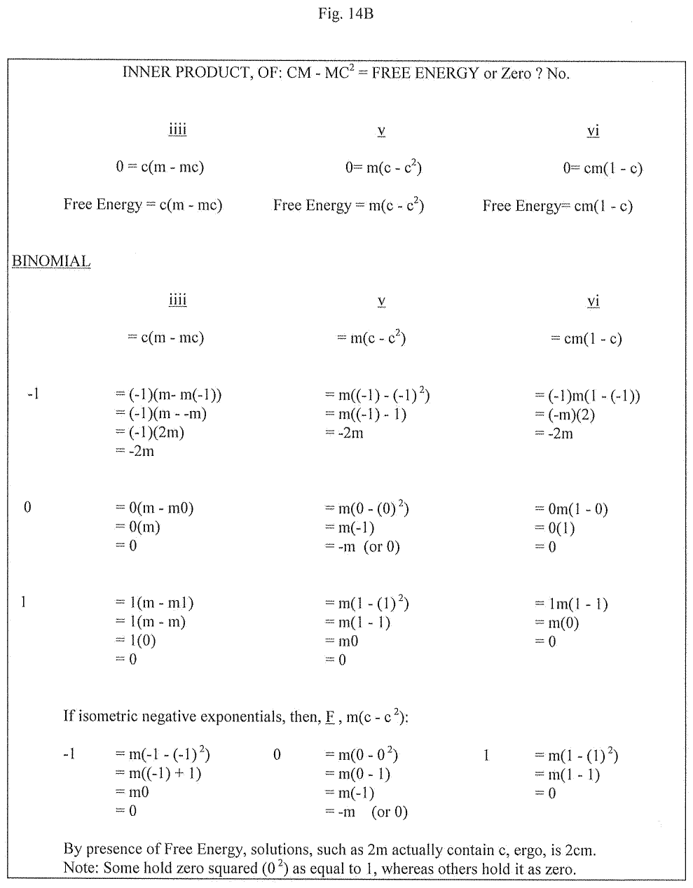

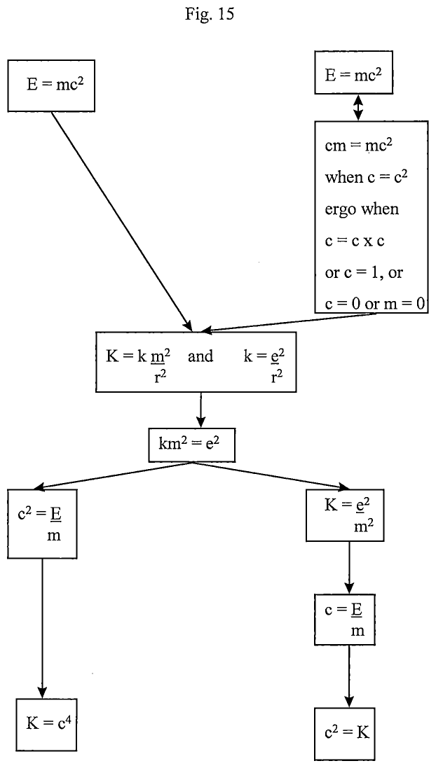

Note: Hand-Inked Drawings are drafted by myself, Inventor David Andrew D'Zmura, also my computer typeset Drawings are rendered by myself, as all are also consistently without exception in all of my cited Intellectual Properties. All Text, Specification, Drawings, Claims and Editing are by David Andrew D'Zmura.

© David Andrew D'Zmura. All Rights Reserved.

By David Andrew D'Zmura, US/US pro-se solo and sole Independent Inventor/Author/Owner in Entirety, a whole and clean Propriety.

What I claim is:

1) A system of economic empowerment structuring business finance, comprising:
a method, wherein Intangible Assets provide improved status on a Balance Sheet of Assets and Liabilities, comprising:
re-booking any Intangible Asset from the Liability-Side if already on book;
placing said Intangible Assets netted present discounted value, if positive, on the Asset-Side of the Balance Sheet; and,
re-balancing the Liability-Side adding measure equivalent said netted present discounted value as Equity;
a Treasury Asset, a financial term instrument manufactured to pay or receive periodic payments, whether actual or be phantom accrual, of interest and/or royalty, comprising:
originating a financial term instrument bearing a Face Value amount, said Face Value approximating Revenue Scope of an underlying or packaged Intangible Asset, optionally a promise of interest or royalty payments to be made or received;
conveying and licensing use and commercialization Rights of said underlying Intangible Asset, said Rights expressly delineated in written Deed of said Treasury Asset unto Party of said Treasury Asset issuance, said Treasury Asset term complying and corresponding with lifetime of protected Rights and Entitlements enveloping said underlying Intangible Asset, said enveloped Rights and Entitlements conveyed in said Treasury Asset;
booking said Treasury Asset to Ledger and/or Balance Sheet, wherein said Treasury Asset Face Value holds measure with book value;
a method by which an inventor's cost of inventing and patenting and protecting intellectual and copyright Rights and Entitlements on own invention, or collection of inventions, comprising protected Intangible Asset, which further comprises:
a Fair Market calculation of the Value, or discounted present value of said invention's aggregate Revenue Scope in Economy, respective lifetime protected royalty earnings, comprising:
summing industry-applicable royalty rate;
determining present discounted value of lifetime royalty aggregate;
dividing by fifteen, yielding fifteen-year straight-line amortization deduction, per annum, each of fifteen years;
availing inventor as tax deduction on royalty received each said given year of fifteen; or
a Demand-Side Stimulus to the general Economy, comprising:
a net-equal value Swap of an inventor's IRS tax Fair Market Value amortization deduction, said deduction availed against royalty received, said Swap to National, municipal or civic governmental body, said body levying tax, issuing bonds, and bearing mass of resident taxpayers, said body swapping appropriate net-equal cash or tangible value equivalent to said inventor, wherein yielding swap rate between said two parties to said Swap, wherein said governmental body using and valuing said inventor's tax FMV deduction, wherein said body distributing to taxpayer residents of said body, said tax deduction aggregate received per said Swap, wherein providing said taxpayer residents per capita, or other formulated division, apportionment said aggregate received via said Swap, which further comprises, functioning to stimulate Economy via atomistic Demand, wherein consumer taxpayers or supplier companies deriving said Demand.

2. A business method for a nation or multiple nations configuring a financial reserve asset, said asset assigned to the accounting ledger of said nation's or nations' central bank(s) or Treasury(ies), wherein comprising:
estimating the wealth of expired Intangible Assets, said expired Intangible Assets comprising the multitude of expired patents, copyrights and trademarks in the national archive;
according said wealth to the public good, wherein booking said financial asset to the public or public-purposed account on the ledger of said central bank(s) and/or Treasury; and
crediting said public account with the financial value of said financial asset.

3. A process producing an inner product, occurring between the two states, large-scale and quantum, wherein having the governing formulas, E=mc² and e=mc, respectively, said inner product produced by cycling of these two said states, in both directions, causing to be directed by mc²−mc, and by mc−mc², wherein said inner product is rendered by solving for the constant speed of light in natural units, whereby a binomial is formed of one or zero, or alternately, negative one, producing 2m per cycle and −2m per cycle, respectively, under dark light/energy, otherwise, zero.

4. In the invention of claim 3, which further comprises the duration, change respective time, governing said process producing said inner product: for large-scale state, K=k(m²/r²); and for quantum state, k=e²/r².

5. In the invention of claim 3, which further comprises duration in terms of the speed of light, wherein: for large-scale state, K=c⁴; and for quantum state, √k=c, and K=c².
